(19) United States
(12) Patent Application Publication
(10) Pub. No.: US 2018/0165347 A1
(43) Pub. Date: Jun. 14, 2018

(54) MULTI-DIMENSIONAL ANALYSIS USING NAMED FILTERS

(71) Applicant: International Business Machines Corporation, Armonk, NY (US)

(72) Inventors: Gregory Fitzpatrick, Feltham (GB); Antonius G. P. Steijvers, Sebastiaanstraat (NL); Jelle A. G. van den Elsen, Weert (NL); Franciscus J. J. van Ham, Geldrop (NL)

(21) Appl. No.: 15/862,689

(22) Filed: Jan. 5, 2018

Related U.S. Application Data
(63) Continuation of application No. 15/374,077, filed on Dec. 9, 2016.

(51) Int. Cl. G06F 17/30

(52) U.S. Cl. CPC G06F 17/30592; G06F 17/30569; G06F 17/30333

(57) ABSTRACT

Computer-implemented, multi-dimensional analysis can include storing, in a memory and using a processor, a named filter dimension as part of a multi-dimensional data model for a database. The named filter dimension includes a plurality of named filters with each named filter having an expression specifying a subset of original data of the database. The named filter dimension can be provided, using the processor, as a selectable option from the multi-dimensional data model for generating a multi-dimensional representation of data retrieved from the database.

### BACKGROUND

This disclosure relates to multi-dimensional analysis. Multi-dimensional analysis refers to a computer-based technology where data is analyzed and presented across multiple different levels or “dimensions.” In multi-dimensional analysis, aspects of the data (measures) are summarized across multiple other aspects of the data (dimensions) and presented to a user in a multi-dimensional format such as a crosstab or visualization view. This method of analysis is often referred to as online analytical processing (OLAP) or data pivoting. An example of a dimension is a column of a dimension table within a database. In this context, a dimension is defined as an identifiable aspect or aspects of the data which refer to measurable information. A dimension is used to categorize measures to support analysis of the data.

Existing multi-dimensional analysis systems are capable of organizing data into hierarchies. Users are able to navigate the data within the hierarchies with greater ease in cases where the data includes potentially huge numbers of values. Existing multi-dimensional analysis systems further aggregate data through levels of the hierarchies to provide summarized views of the data. A user may drill down beneath the aggregated data to view the lower levels of the hierarchies when more detail is needed.

### SUMMARY

One or more embodiments are directed to computer-implemented methods of multi-dimensional data analysis. In one aspect, a method can include storing, in a memory and using a processor, a named filter dimension as part of a multi-dimensional data model for a database. The named filter dimension includes a plurality of named filters with each named filter having an expression specifying a subset of original data of the database. The method can include providing, using the processor, the named filter dimension as a selectable option from the multi-dimensional data model for generating a multi-dimensional representation of data retrieved from the database.

One or more embodiments are directed to systems for multi-dimensional data analysis. In one aspect, a system includes a memory adapted to store a named filter dimension as part of a multi-dimensional data model for a database. The named filter dimension includes a plurality of named filters with each named filter having an expression specifying a subset of original data of the database. The system can include a processor coupled to the memory and configured to initiate executable operations. The executable operations can include providing the named filter dimension as a selectable option from the multi-dimensional data model for generating a multi-dimensional representation of data retrieved from the database.

One or more embodiments are directed to a computer program product for multi-dimensional data analysis. In one aspect, the computer program product includes a computer readable storage medium having program code stored thereon. The program code is executable by a processor to cause the processor to perform a method. The method can include storing, in a memory and using the processor, a named filter dimension as part of a multi-dimensional data model for a database. The named filter dimension includes a plurality of named filters with each named filter having an expression specifying a subset of original data of the database. The method can include providing, using the processor, the named filter dimension as a selectable option from the multi-dimensional data model for generating a multi-dimensional representation of data retrieved from the database.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example network computing system.

FIG. 2 illustrates an example architecture for a data processing system.

FIG. 3 illustrates an example of a visualization generated by a conventional multi-dimensional analysis system.

FIG. 4 illustrates an example of a visualization of multi-dimensional data using a named filter dimension.

FIG. 5 illustrates an example method of creating a named filter.

FIG. 6 illustrates an example method of using a named filter dimension to retrieve data and generate a report.

FIG. 7 illustrates an example visualization generated by the data engine of FIG. 1.

FIG. 8 illustrates another example visualization generated by the data engine of FIG. 1.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the embodiments described herein in virtually any appropriately detailed structure. Further, the terms and phrases used within this disclosure are not intended to be limiting, but rather to provide an understandable description of the embodiments presented.

This disclosure relates to multi-dimensional analysis. One or more embodiments described within this disclosure relate to using named filters for multi-dimensional analysis. A system is capable of creating and storing named filters. Within the system, the named filters become members of a virtual “named filter.” In one example, a named filter may be defined as an expression involving one or more aspects or columns of the input data. Once saved within the system, the set of named filters is available as a dimension like any other dimension. Unlike other dimensions that rely upon static attributes in the data, however, the named filter dimension is dynamic which results from the definitions of the named filters.

In one or more embodiments, users of the system, e.g., end users, are permitted to create named filters. As such, an end user of the system, as opposed to a user with administrative privileges, for example, is capable of providing input to the system to define one or more named filters. The system is capable of storing the named filters and making the named filters available to the end user(s) for purposes of retrieving data and/or creating reports. Each named filter may be used to dynamically determine, or filter, a portion of data within the context of the report and/or within parts of the report. As used within this disclosure, the term “report,” means a multi-dimensional view or representation of data. An example of a report is a visualization of multi-dimensional data.

As an illustrative example, the system is capable of generating a visualization of the data or a portion thereof. The system is capable of exposing one or more stored named filter dimensions, or members thereof, to the user for use in defining the report to be rendered. Within this disclosure, named filters are considered members of a particular named filter dimension. The named filter dimension, for example, may be assigned to an aspect of the report such as an axis. With this capability, the system is able to create a report that compares data from the named filters for members from any given dimension.

For purposes of illustration, a “dimension member” or “member of a dimension” refers to an element or item that belongs to a dimension. In illustration, a dimension may directly correspond to a value in a column in the original input data. For example, a data set may include a date column that manifests itself in the multi-dimensional representation of that data as a date dimension. The dimension will have members organized into a hierarchical structure. Some of the members relate directly to values in the data set, while others may be aggregations of the dates. It is also possible to define calculated members, e.g., “Last 3 Years”=2016+2015+2014, which become members of the dimension as well. Accordingly, a visualization showing a multi-dimensional view of data is generally described in terms of the dimensions (hierarchies) that should be shown and which members of those dimensions are selected for inclusion.

Further aspects are described herein in greater detail with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

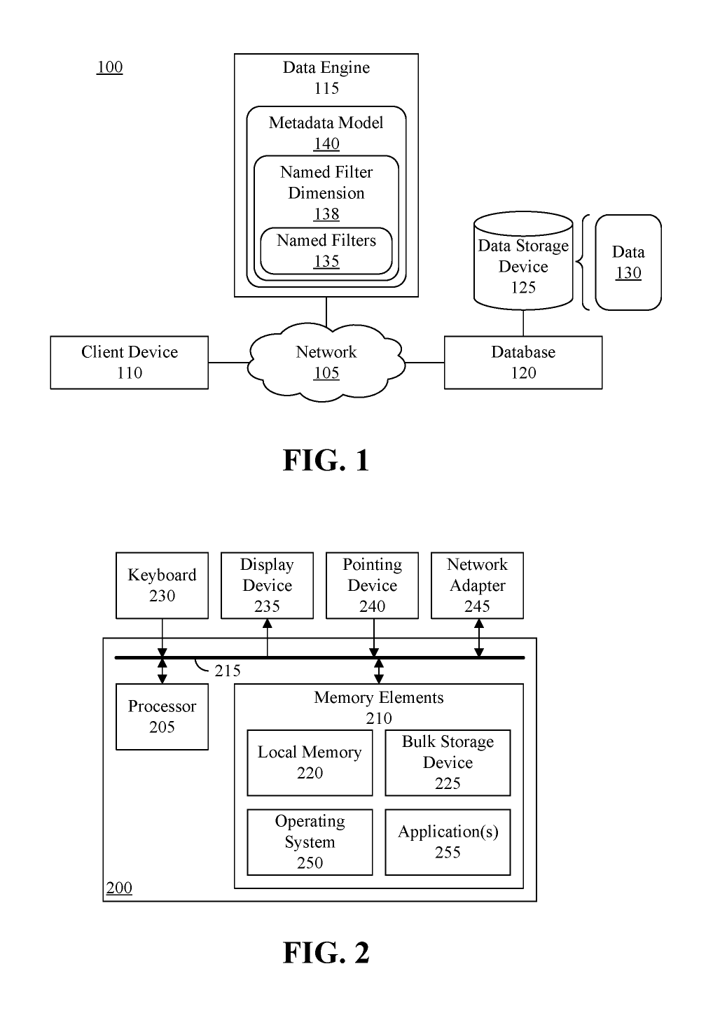

FIG. 1 illustrates an example of a network computing system 100 in which one or more embodiments of the present invention may be implemented. Network computing system 100 contains a client device 110, a data engine 115, and a database 120. Network computing system 100 further may include a data storage device 125 storing data 130 therein as one or more data structures. Client device 110, data engine 115, and database 120 are interconnected, e.g., communicatively linked, by a network 105.

Network 105 is the medium used to provide communication links between various devices and data processing systems connected together within network computing system 100. Network 105 may include connections, such as wired communication links, wireless communication links, or fiber optic cables. Network 105 may be implemented as, or include, one or more or any combination of different communication technologies such as a Wide Area Network (WAN), a Local Area Network (LAN), a wireless network (e.g., a wireless WAN and/or a wireless LAN), a mobile or cellular network, a Virtual Private Network (VPN), the Internet, the Public Switched Telephone Network (PSTN), and so forth.

Client device 110 is coupled to data engine 115 through network 105. Client device 110 may be implemented as a personal computer, a portable computing or communication device, a network computer, a tablet computer, a mobile phone (e.g., a smart phone), or the like. Client device 110, for example, is operative to provide, or operate as, a user interface through which a user may interact with data engine 115 and/or database 120.

Data engine 115 is coupled to client device 110 and to database 120 through network 105. Data engine 115 may be implemented as a data processing system such as a computer, server, and so forth. In one aspect, data engine 115 may be implemented as one or more interconnected, e.g., networked, data processing systems. Data engine 115 is capable of executing suitable operational software to support the various operations described herein. For example, data engine 115 is configured to create and store named filters 135 to be described herein in greater detail as members of a named filter dimension.

In one or more embodiments, data engine 115 is implemented as a processing layer that executes on top of database 120. For example, data engine 115 may perform functions as an intermediary or as middleware between client device 110 and database 120. Data engine 115 is capable of receiving requests from client device 110 specifying a named filter dimension and/or members thereof (e.g., one or more named filters), requesting data, and/or requesting a report. Data engine 115 is capable of translating such requests and forwarding the translated requests to database 120. Results from database 120 are received by data engine 115, processed, and provided to client device 110 as described herein.

Database 120 is coupled to data engine 115 through network 105. Database 120 may be implemented as a data processing system such as a computer, server, and so forth. In one aspect, database 120 may be implemented as one or more interconnected, e.g., networked, data processing systems. Database 120 is capable of executing suitable operational software to support the various operations described herein. In one or more embodiments, database 120 is implemented as a relational database management system (RDBMS).

Database 120 is communicatively linked to data storage device 125. As noted, data storage device 125 includes the various data structures utilized by database 120 to store data 130. While shown as a separate entity from database 120, it should be appreciated that data storage device 125 may be integrated within, or be part of, database 120.

In one or more embodiments, client device 110 communicates with data engine 115 to create one or more of named filters 135 as members of a named filter dimension 138. For example, data engine 115, in response to instructions from client device 110, creates one or more named filters 135 that may be stored within data engine 115. Data engine 115 may generate and store named filters 135 as members of named filter dimension 138 as part of a metadata model 140. Data engine 115 stores metadata model 140 in a memory or other type of data storage device. Thus, throughout this disclosure, a named filter (filters) may be referred to as a member (members) of the named filter dimension.

For example, named filters 135 may be stored as members of named filter dimension 138 within metadata model 140. In another example, data engine 115 may store named filters 135 as members of named filter dimension 138 as an extension of metadata model 140. Metadata model 140 describes data 130. Metadata model 140 may be built to define multi-dimensional characteristics of data 130 such as hierarchies, measures, aggregation rules, etc. In one example, metadata model 140 is a multi-dimensional data model.

In another embodiment, data engine 115 is capable of storing named filter dimension 138 and/or members thereof with, or as part of, a list of dimensions of data 130. Data engine 115, for example, is capable of exposing the dimensions of data 130, including named filter dimension 138 and/or members thereof to client device 110.

Client device 110 further is capable of instructing, or requesting, data engine 115 to retrieve data and/or construct a report that includes named filter dimension 138 and/or one or more of named filters 135. For example, in response to a request from client device 110, data engine 115 is capable of creating, storing, and/or executing a report using database 120. The report may be a visualization that includes named filter dimension 138 and, as such, one or more of named filters 135.

As defined within this disclosure, a named filter is specified as a data structure having a name and a definition. A filter definition is an expression that may include one or more conditions linked together by Boolean operators. Conditions may include functions and arithmetic operators. The filter definition operates on, or is applied to, original data 130. The filter definition may be applied to original data indirectly, e.g., through translation into one or more database queries as described herein. In one example implementation, a filter definition is a Boolean expression.

As an illustrative example, a condition may be “name begins with A.” Another example of a condition may be “City=London” or “City=Manchester.” Another example of a condition may be “Customer IN (Cust1, Cust2) AND Sales>100.” An example of a function may be “ABS(transaction_amount)>100.” Thus, a named filter may specify one or more conditions joined by Boolean operators. For purposes of illustration, conventional systems are based upon aspects of data, which are typically columns in the case of tabular data. The named filter dimension is an additional dimension that is virtual because the named filter dimension is not based on a column or columns. The named filter dimension is based upon, or built, by a set of named filters. Each named filter may target a set of rows in the original data according to the definition of the named filter. As such, each named filter may be said to specify a subset of the original data.

As defined herein, the term “original data” means data input into the system, e.g., database 120. Original data further can refer to such data in a form or structure prior to aggregation and/or summarization. Thus, for example, a named filter specifies an expression that is operative on data 130, e.g., rows and/or columns of data 130, prior to aggregation and/or summarization. As noted, a named filter, once stored within data engine 115 and available for use in generating reports of data 130, may be referred to as a member of the named filter dimension.

In one or more embodiments, a named filter is dynamic since the named filter has a definition specifying an expression, whose results are not determined until a multi-dimensional view including that named filter is executed. Because named filters are applied to, or operate on, original data, a named filter is able to target the data in a more detailed way than is possible using conventional dimensions. Moreover, end users are able to define named filters as needed thereby adding additional members of the named filter dimension without having to change the underlying data structures of database 120.

In further illustration, named filters may be adapted to target rows in multi-dimensional data in a flexible manner. A named filter, for example, may specify a set of one or more conditions to apply to values that may use one or more functions, arithmetic operators, etc. Named filters are further capable of combining conditions across different columns in the multi-dimensional data. As such, named filter dimension 138 may be added into a visualization of multi-dimensional data in the same or similar way that conventional dimensions are added or used in the visualization. The named filter dimension, however, is dynamically determined as opposed to conventional dimensions.

As an illustrative example, named filter dimension 138 may be explicitly selected by a user working through client device 110 from a list of dimensions for use in generating a report. Further, one or more members, e.g., named filters 135, may be selected for use in generating the report. Named filter dimension 138, for example, may be included in a “TopN” statement for selecting the top “N” members of a list. A member or members of named filter dimension 138, e.g., named filters 135, may be included as input into member calculations. A member calculation is a member of a dimension that is defined by a formula. The formula can include references to other members, arithmetic operations, literal numbers, and functions.

For purposes of illustration, consider an example where a user defines named filters 135 as part of named filter dimension 138. Named filter dimension 138 may be used in a request for multi-dimensional data. For example, named filter dimension 138 may be included on an axis in the request. An example request is shown below in Example 1.

### Example 1

Axis 0

Countries dimension

Axis 1

Named filter dimension

Axis 2

Measures dimension

A user may also choose which members of a dimension should be selected for each dimension in the request. An updated version of the request is shown in Example 2 where members of the dimensions are selected.

### Example 2

Axis 0

Countries dimension

Select all countries

Axis 1

Named filter dimension

Select top 3 based on cost

Axis 2

Measures dimension

Select “sales”

FIG. 1 is provided for purposes of illustration and is not intended to be limiting of the embodiments described herein. It should be appreciated that network computing system 100 may include fewer elements than shown or more elements than shown. For example, network computing system 100 may include fewer or more servers, clients, and other devices. In addition, one or more of the elements illustrated in network computing system 100 may be merged or combined. In one or more embodiments, data engine 115 and database 120 may be implemented within a same data processing system.

FIG. 2 illustrates an example architecture 200 for a data processing system. Architecture 200 may be used to implement a device that is suitable for storing and/or executing program code. In one example, architecture 200 is used to implement client device 110 of FIG. 1. In another example, architecture 200 is used to implement data engine 115 and/or database 120 of FIG. 1.

Architecture 200 includes at least one processor 205, e.g., a central processing unit (CPU), coupled to memory elements 210 through a system bus 215 or other suitable circuitry. Architecture 200 stores program code within memory elements 210. Processor 205 executes the program code accessed from memory elements 210 via system bus 215. In one aspect, architecture 200 may be used to implement a computer or other data processing system that is suitable for storing and/or executing program code. It should be appreciated, however, that architecture 200 may be used to implement any system including a processor and memory that is capable of performing the functions described within this disclosure.

Memory elements 210 include one or more physical memory devices such as, for example, a local memory 220 and one or more bulk storage devices 225. Local memory 220 may be implemented as a random access memory (RAM) or other non-persistent memory device(s) generally used during actual execution of the program code. Bulk storage device 225 may be implemented as a hard disk drive (HDD), solid state drive (SSD), or other persistent data storage device. Architecture 200 also may include one or more cache memories (not shown) that provide temporary storage of at least some program code in order to reduce the number of times program code must be retrieved from the bulk storage device during execution.

Input/output (I/O) devices such as a keyboard 230, a display device 235, a pointing device 240, and one or more network adapters 245 optionally may be coupled to architecture 200. The I/O devices may be coupled to architecture 200 either directly or through intervening I/O controllers. Architecture 200 may include one or more additional I/O device(s) beyond the examples provided. In some cases, one or more of the I/O device(s) may be combined as in the case where a touch sensitive display device 235 (e.g., a touchscreen) is used. In that case, display device 235 may also implement keyboard 230 and/or pointing device 240.

Network adapter 245 is a communication circuit configured to establish wired and/or wireless communication links with other devices. The communication links may be established over a network or as peer-to-peer communication links. Accordingly, network adapter 245 enables architecture 200 to become coupled to other systems, computer systems, remote printers, and/or remote storage devices through intervening private or public networks. Example network adapter(s) 245 may include, but are not limited to, modems, Ethernet cards, bus adapters, connectors, ports, and so forth. Other examples of network adapter 245 may be a wireless transceiver and/or a wireless radio. Network adapter(s) 245 may be configured for short and/or long range wireless communications.

Memory elements 210 store an operating system 250 and an application 255. Operating system 250 and application 255, being implemented in the form of executable program code, are executed by architecture 200. As such, operating system 250 and/or application 255 may be considered an integrated part of any system implemented using architecture 200. Application 255 and any data items used, generated, and/or operated upon by architecture 200 while executing application 255 are functional data structures that impart functionality when employed as part of architecture 200. An example of such a data structure is a named filter dimension.

As defined within this disclosure, a “data structure” is a physical implementation of a data model's organization of data within a physical memory. As such, a data structure is formed of specific electrical or magnetic structural elements in a memory. A data structure imposes physical organization on the data stored in the memory as used by a processor.

In the case where architecture 200 or another similar thereto is used to implement data engine 115, operating system 250 may be a server-side operating system; and, application 255 may be a server-side application that, when executed, causes the system to perform the various operations described herein in connection with data engine 115.

In the case where architecture 200 or another similar thereto is used to implement database 120, operating system 250 may be a server-side operating system; and, application 255 may be a server-side application that, when executed, causes the system to perform the various operations described herein in connection with database 120.

In the case where architecture 200 or another similar thereto is used to implement client device 110 of FIG. 1, operating system 250 may be a client-side operating system; and, application 255 may be a client-side application that, when executed, causes the system to perform the various operations described herein in connection with client device 110.

Table 1 illustrates an example of data 130 that may be stored in data storage device 125. Table 1 shows the multi-dimensional data in an original or “raw” state prior to aggregation and/or summarization. The multi-dimensional data includes different customers, the country in which the customer is located, and sales for years 2010 and 2011.

TABLE 1

| Country | Customer | Year | Sales |
|---|---|---|---|
| UK | A | 2010 | 100 |
| UK | B | 2010 | 30 |
| UK | C | 2010 | 130 |
| UK | D | 2010 | 75 |
| UK | A | 2011 | 123 |
| UK | B | 2011 | 50 |
| UK | C | 2011 | 110 |
| UK | D | 2011 | 80 |
| France | E | 2010 | 45 |
| France | F | 2010 | 90 |
| France | G | 2010 | 200 |
| France | E | 2011 | 50 |
| France | F | 2011 | 80 |
| France | G | 2011 | 150 |

Table 2 illustrates examples of named filters. The named filters may be created by data engine 115 responsive to user requests to do so and stored in data engine 115 as members of named filter dimension 138. As pictured, each named filter is formed of a “name” of the filter and a definition. The definition is evaluated to determine the set of rows in the data which match the named filter.

TABLE 2

| Named Filter | Definition |
|---|---|
| Target Customers | A, B |
| Target Customers (Large Transactions) | [A, B] AND Sales > 100 |
| Long-Shot Customers | E, D |
| Large Transactions | Sales > 100 |
| Medium Transactions | Sales > 50 AND <= 100 |
| Small Transactions | Sales <= 50 |

The named filters include examples that are operative, e.g., are applied, across a plurality of columns or attributes of the data. For example, the “Target Customers (Large Transactions)” named filter dimension has a definition, e.g., an expression, that is operative across both the customer and the sales dimensions of the data.

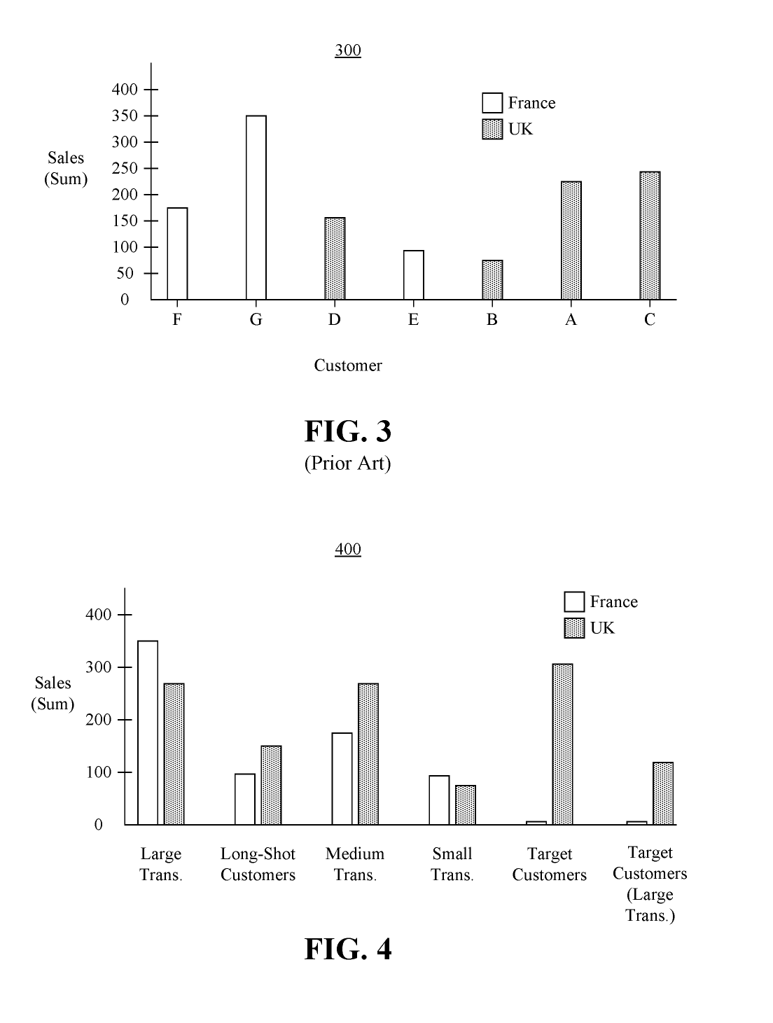

FIG. 3 illustrates an example of a visualization 300 generated by a conventional multi-dimensional analysis system. Visualization 300 is generated from Table 1. Visualization 300 utilizes customer and country dimensions along with the Sales member of the measures dimension. The horizontal axis of visualization 300 is assigned to the customer dimension. The vertical axis of visualization 300 is assigned to the sales measure. Sales are aggregated on the vertical axis for the years 2010 and 2011 for each customer. Visualization 300 indicates whether each customer is located in France or the UK based upon color coding (shading in this example).

FIG. 4 illustrates an example of a visualization 400 using the named filter dimension. The named filters described with reference to Table 2 are stored within data engine 115 as members of the named filter dimension and are available for use by users in defining reports such as visualizations. In one aspect, the named filter dimension is functionally equivalent to any other dimension of the multi-dimensional data model (e.g., metadata model 140). Accordingly, visualization 400 may be generated by data engine 115 in response to a user request to do so. The vertical axis is assigned to sales and indicates the sum of sales over the years 2010 and 2011. The horizontal axis, rather than being assigned to a particular or single dimension of the data, is assigned to the named filters of Table 2. FIG. 4 illustrates that named filters are directly accessible by users when generating a report and are usable by data engine 115 in the same manner as any other dimension of the original data.

FIG. 4 further illustrates the case where the named filter dimension is assigned to the horizontal axis for comparison of aggregated values for each member of the named filter dimension. Because data engine 115 is capable of using the named filter dimension in the same way as any other dimension, data engine 115 is capable of sorting the members of the named filter dimension. Named filters are operative on the original data prior to aggregation, thereby providing fine-grained targeting of rows of the input data; something that is not available with conventional multi-dimensional analysis.

In another illustrative example, a first named filter may specify companies in a particular country, e.g., Country A. A second named filter may specify companies that make over a particular amount of money per year. A visualization that uses both of the named filters along the horizontal axis may have a visual such as a bar for the first named filter and a second visual such as a bar for the second named filter. A company “X” may be counted in both of the bars in the case where the company meets the definitions of both of the first and second named filters. A conventional multi-dimensional analysis system is unable to generate such a visualization.

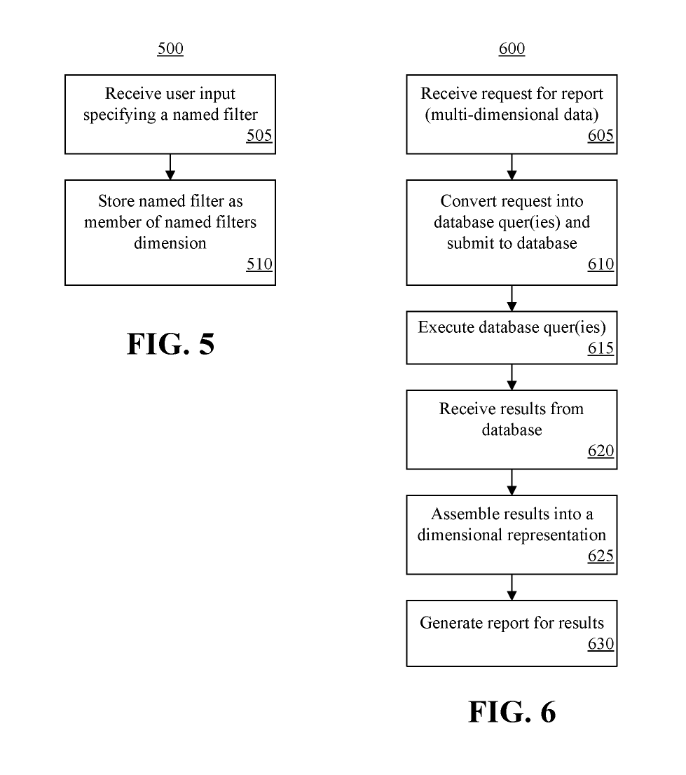

FIG. 5 illustrates an example method 500 of creating a named filter. Method 500 may be performed by data engine 115 of FIG. 1. In bock 505, the data engine receives data specifying a named filter from a client device. For example, the data may be obtained from a user input requesting the creation of a named filter. The data may specify a name of a named filter and a definition for the named filter.

In block 510, the data engine stores the named filter as a member of the named filter dimension within a data storage device. In one or more embodiments, the named filter dimension is stored. The named filter dimension may be stored with a set of the dimensions, e.g., other dimensions, of the multi-dimensional data. The named filter dimension and the set of dimensions are exposed to the user for use in creating reports from the multi-dimensional data. For example, the named filter dimension (or members thereof) is selectable, by a user, for inclusion in a request for data, a report, or the like in generating a query result from a database. It should be appreciated that the named filter dimension and/or members thereof may be provided as selectable options (e.g., exposed) with or without providing other dimensions as selectable options.

FIG. 6 illustrates an example method 600 of using a named filter dimension to retrieve data and generate a report. Method 600 may be performed by data engine 115 of FIG. 1. In block 605, the data engine receives a request for data from a client device. The request may also request the data in the form of a report. The report requested may be a visualization such as a multi-dimensional view. The request may be specified by one or more user inputs. The request includes the data necessary to define the multi-dimensional view to be generated. Further, the request indicates that the report, e.g., a multi-dimensional view, includes or uses one or more named filters.

An example of a request specifying a multi-dimensional view is shown below as Example 3.

### Example 3

Named filters:

Large Transactions: Sales > 100
Long-Shot Customers: (‘A’, ‘B’)

Axis 0

select all Named Filters

Axis 1

select Years 2010, 2011

Axis 2

Select measure sales

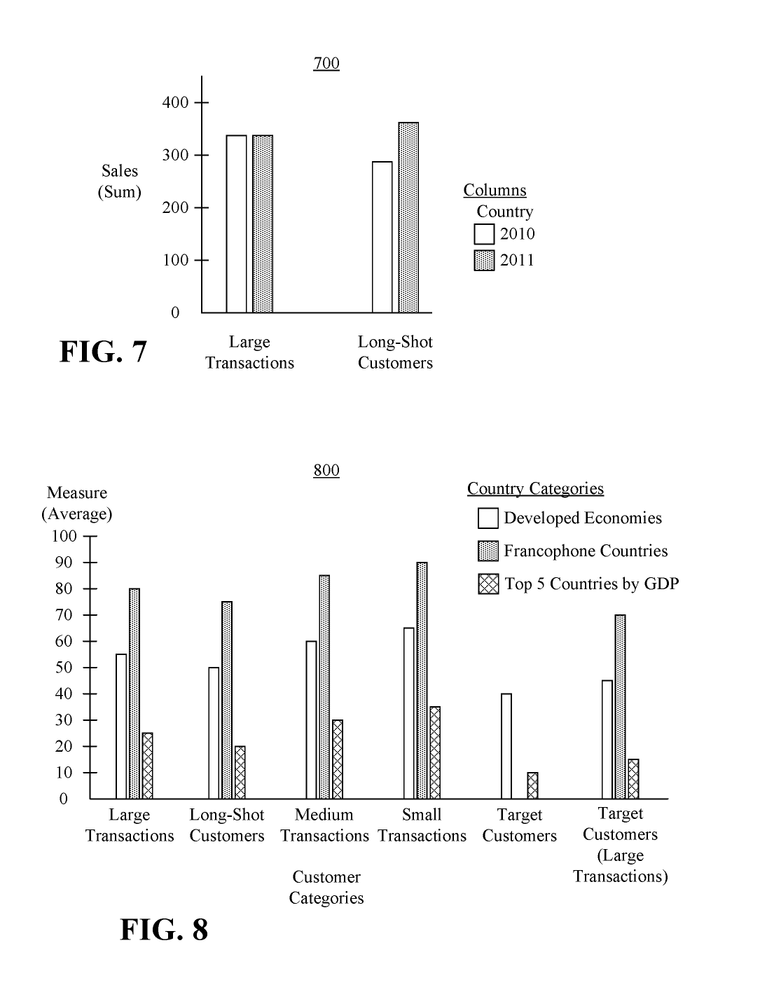

In Example 3, the request includes a section listing each of the named filters that are to be included in the multi-dimensional view. Further, the request indicates that each of the named filters listed is assigned to Axis 0, e.g., the horizontal axis. Thus, in this example, the horizontal axis will indicate “Large Transactions” and “Long-Shot Customers”. The request indicates that Axis 1, which corresponds to the color series in the visualization, corresponds to the “Years” dimension with 2010 and 2011 being selected. Thus, the data engine interprets the request to specify that the horizontal axis lists data for each of years 2010 and 2011 for each of the named filter dimensions. The request indicates that Axis 2, corresponding to the vertical axis, is assigned the sales measure. FIG. 7 illustrates an example visualization.

It should be appreciated that the data engine is adapted to expose any of the dimensions of the data as well as the named filter dimension to users for use in requesting data and/or creating reports.

In another embodiment, the client device may communicate with the data engine and present a user interface through which the user may specify the request. The data engine, for example, may send the user interface to the client device for rendering to the user. In one example, the user interface may be provided as a Webpage, though the embodiments described herein are not intended to be limited by the particular type of interface generated and/or provided to the client device from the data engine. Within the user interface, the dimensions of the database and the named filter dimension can be listed as selectable options. The user interface may also list each of the members of the named filter dimension as selectable options. Through the user interface, user inputs specifying the request shown in Example 1 may be received to assign dimensions, named filter dimensions, and/or members thereof to one or more axes and/or other aspects of the multi-dimensional view to be generated.

In block 610, the data engine converts the request into one or more database queries and submits the database queries to the database for execution. In response to receiving the request, the data engine operates on the request to convert the request to a syntax that is understood by the database. The data engine is capable of converting the named filters into database queries. In one embodiment, the request, including the named filter dimensions, are converted into Sequel (SQL) statements or another database language suitable for specifying and submitting queries. Example 4 illustrates a simplified example database query resulting from translation of the request of Example 3. The data engine, having generated the database queries, submits the database queries to the database.

### Example 4

SELECT ‘Large Transactions’ AS ‘Named Filters’, [Year], SUM(Sales)
FROM Sales
WHERE Sales > 100
GROUP BY Year
UNION
SELECT ‘Long-Shot Customers’, [Year], SUM(Sales)
FROM Sales
WHERE Customer IN (‘A’, ‘B’)
GROUP BY Year

In block 615, the database receives the database query from the data engine and executes the database query against the data. Table 3 illustrates example results obtained from executing the database query of Example 4 against the data of Table 1.

TABLE 3

| | Named Filters | Year | Sum Sales |
|---|---|---|---|
| 1 | Large Transactions | 2010 | 330 |
| 2 | Large Transactions | 2011 | 383 |
| 3 | Long-Shot Customers | 2010 | 130 |
| 4 | Long-Shot Customers | 2011 | 173 |

Examples 3 and 4 are provided for purposes of illustration only. In this regard, Examples 3 and 4 present simplified cases where a single query is generated. It should be appreciated that a more complex request may be translated into multiple queries that may be executed against the data.

In block 620, the data engine receives results from execution of the database queries from the database. For example, the database may return the data shown in Table 3 to the data engine in response to executing the database queries.

In block 625, the data engine assembles the results received from the database into a dimensional representation. The data engine, for example, in response to receiving the results, structures the results. The results may be provided in tabular format. The data engine is capable of structuring the results and generating a multi-dimensional representation that corresponds to the request received in block 605. Example 5 illustrates the conversion of the database results shown in Table 3 into a multi-dimensional representation.

### Example 5

Axis 0

Large Transactions, Long-Shot Customers

Axis 1

2010, 2011

Axis 2

Sales

Values

330, 383, 130, 173

As illustrated, the data from Table 3 is structured according to the various defined Axes, with the values ordered last. The definition of the axes, at least Axis 0 in this example, utilizes the named filter dimension. As such, the data engine, at least in part, structures the results received from the database based upon the named filter dimension of the request.

In block 630, the data engine generates a report for the results. As discussed, the report is a multi-dimensional view of the data presented in a visualization. A system, e.g., another system, is capable of rendering a visualization of the multi-dimensional representation of the query results. The report may be provided to the client device. The report further may be specified in any of a variety of formats. For example, the data engine may deliver the report to the client device as a markup language file, or the like.

FIG. 7 is an example visualization 700 generated by data engine 115 of FIG. 1. Visualization 700 is an example generated from the dimensional representation of data shown in Example 3. FIG. 7 illustrates the assignment of named filters to an aspect of the multi-dimensional representation. In the example of FIG. 7, an aspect of the multi-dimensional representation is an axis. An “aspect,” as applied to a multi-dimensional representation, refers to a feature of a visual representation representing data. As such, the term “aspect,” as applied to a multi-dimensional representation is not intended to be limited to an axis or the examples provided. For example, in the case of a “bubble chart,” dimensions may be mapped to aspects of the multi-dimensional representation such as bubbles. In another example, “aspects of a multi-dimensional representation” may be referred to as dimensions of the visualization.

In another embodiment, the named filter dimension may be used as part of a definition of a hierarchical dimension. One or more of the named filters of a named filter dimension may be used within the definition of a hierarchal dimension. Referring again to Table 2, the named filters shown therein may be used as a level within a hierarchy. An example of a hierarchical dimension is shown below in Example 6. Within the hierarchical dimension of Example 6, “Countries” is the first level of the hierarchy. The set of named filters of Table 2 is the second level of the hierarchy. The hierarchical dimension of Example 6 may be included in a request for multi-dimensional data. The results of the request may be placed into a visualization, e.g., a report.

### Example 6

All Countries

Country A

Target Customers
Target Customers (Large Transactions)
Long-shot Customers
...

Country B

Target Customers
Target Customers (Large Transactions)
Long-shot Customers
...

In another aspect, the data engine may be adapted to support multiple named filter dimensions. In that case, each named filter dimension may include one or more members, e.g., named filters. As such, each of the named filter dimensions may be exposed as a dimension in order to formulate a database query and/or generate a report. As an illustrative example, the data engine may include two named filter dimensions. The first named filter dimension may be that shown in Table 2. The second named filter dimension may be the example shown in Table 4. For ease of illustration, the definitions of the named filters of the named filter dimension of Table 4 are not shown.

TABLE 4
Country Categories

Top 5 Countries by GDP
Developed Economies
European Union
Asia and the Pacific
Francophone Countries

FIG. 8 is an example visualization generated by data engine 115 of FIG. 1 using the named filter dimensions of Tables 2 and 4. The named filter dimensions are assigned to different axes, thereby facilitating comparison of intersections in the data.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the term “another” means at least a second or more.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “coupled” means connected, whether directly without any intervening elements or indirectly with one or more intervening elements, unless otherwise indicated. Two elements may be coupled mechanically, electrically, or communicatively linked through a communication channel, pathway, network, or system.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “plurality” means two or more than two.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method of multi-dimensional data analysis, comprising:
storing, within a memory and using a processor, a named filter dimension as part of a multi-dimensional data model for a database;
wherein the named filter dimension includes a plurality of named filters with each named filter having an expression specifying a subset of original data of the database; and
providing, using the processor, the named filter dimension as a selectable option from the multi-dimensional data model for generating a multi-dimensional representation of data retrieved from the database.

2. The method of claim 1, further comprising:
converting data retrieved from the database into a multi-dimensional representation including the named filter dimension.

3. The method of claim 1, wherein the named filter dimension is functionally equivalent to other dimensions of the multi-dimensional data model.

4. The method of claim 1, wherein the expression of each named filter is operative across a plurality of attributes of the original data of the database.

5. The method of claim 4, wherein the expression of each named filter specifies a plurality of conditions logically combined using Boolean operators.

6. The method of claim 1, wherein the plurality of named filters of the named filter dimension are provided as selectable options.

7. The method of claim 1, wherein at least one of the named filters is assigned to an aspect of the multi-dimensional representation.

8. The method of claim 1, wherein the named filter dimension or at least one named filter of the named filter dimension is used as a level in a definition of a hierarchical dimension.

9. The method of claim 1, further comprising:
converting a request for data from the database into a database query, wherein the request includes the named filter dimension and the database query is executed by the database; and
receiving a query result from the database in response to executing the database query.

10-20. (canceled)
